(19) United States
(12) Patent Application Publication
(10) Pub. No.: US 2018/0326760 A1
(43) Pub. Date: Nov. 15, 2018

(54) TAPE PROCESSING DEVICE AND TAPE PROCESSING METHOD

(71) Applicant: SEIKO EPSON CORPORATION, Tokyo (JP)

(72) Inventor: Taishi SASAKI, Matsumoto-shi (JP)

(73) Assignee: SEIKO EPSON CORPORATION, Tokyo (JP)

(21) Appl. No.: 15/755,814

(22) PCT Filed: Aug. 26, 2016
(86) PCT No.: PCT/JP2016/003892

§ 371 Date: Feb. 27, 2018

(30) Foreign Application Priority Data
Aug. 28, 2015 (JP) 2015-168737

(51) Int. Cl. B41J 11/70; B41J 15/04; B41J 11/00; B41J 3/407

(52) U.S. Cl. CPC B41J 11/70; B41J 3/4075; B41J 11/0095; B41J 15/04

(57) ABSTRACT

A tape processing device includes a sending and processing section that performs a tape process while sending processing tape, a cutting section that is disposed on a downstream side of the sending and processing section in a tape sending direction and cuts the tape-processed processing tape, a discharging section that is disposed on the downstream side of the cutting section in the tape sending direction, feeds the processing tape, and holds the cut processing tape, a sending and interlocking section that interlocks driving of the sending and processing section and driving of the discharging section, and a sensing section that determines presence and absence of the processing tape held in the discharging section.

### TECHNICAL FIELD

The present invention relates to a tape processing device, and a tape processing method.

### BACKGROUND ART

In the related art, as a tape printing device, a tape printing device including a platen and a printing head that perform printing on a processing tape while sending the processing tape, a full cut mechanism that cuts off a tape piece which is a printed part of the processing tape, and a tape piece discharging mechanism that forcibly discharges the tape piece to the outside of the device is known (refer to PTL 1). The full cut mechanism is constituted of a cutter, a cutter actuating mechanism that actuates the cutter to perform a cutting operation, and a cutter motor that serves as a driving source. Meanwhile, a tape discharging mechanism includes a discharging roller, a roller shaft that supports the discharging roller so as to be rotatable, a power transmission mechanism that rotates the discharging roller, and a discharging assistance roller that pinches the tape piece and faces the discharging roller, and the above-described cutter motor is also used as a power source. Also, the discharging roller rotates in synchronization with the cutting operation of the cutter.

### CITATION LIST

### Patent Literature

PTL 1: JP-A-2002-167092

### SUMMARY OF INVENTION

### Technical Problem

However, in the above-described tape printing device of the related art, the discharging roller rotates in synchronization with the cutting operation of the cutter, and thus, at the time of tape sending, the discharging roller stops the rotation. That is, at the time of introducing the processing tape into the cutting mechanism, when a distal end of the processing tape arrives at the tape piece discharging mechanism, there is a problem in that a paper jam in which the distal end of the processing tape is stuck in a pinched portion between the discharging roller and the discharging assistance roller is generated. In addition, the tape piece discharging mechanism forcefully discharges the tape piece, and thus the tape piece is flown in all directions, and there is a problem in that the discharging position is not stable. In addition, the discharging of the tape piece by the tape piece discharging mechanism finishes a series of operations (one cycle) of the tape printing device, and thus there is another problem in that an operation for starting the subsequent tape process is required.

### Solution to Problem

The invention provides to solve at least a part of the above-described problems and can be realized in the following forms or as the following application examples.

### Application Example 1

A tape processing device according to the present application example includes a sending and processing section that performs a tape process while sending a processing tape, a cutting section that is disposed on a downstream side of the sending and processing section in a tape sending direction and cuts the tape-processed processing tape, a discharging section that is disposed on the downstream side of the cutting section in the tape sending direction, feeds the processing tape, and holds the cut processing tape, a sending and interlocking section that interlocks driving of the sending and processing section with driving of the discharging section, and a sensing section that determines presence and absence of the processing tape held in the discharging section.

According to the tape processing device of the application example, it is possible to interlock (synchronize) the driving of the sending and processing section with the driving of the discharging section using the sending and interlocking section, and thus, even during the introduction of processing tape into the cutting section, the discharging section is in operation. Therefore, at this time, when the distal end of the processing tape arrives at the discharging section, the distal end of the processing tape is smoothly pulled into the discharging section, and thus a paper jam is not generated.

In addition, the discharging section is constituted to feed the processing tape to the outside of the device so as to extend the tape sending of the sending and processing section, and thus the cut portion of the processing tape (tape piece) is not flown in all direction, and it is possible to stabilize the discharging position.

In addition, it is possible to determine the presence and absence of the processing tape held in the discharging section using the sensing section and move to the next operation based on the determined result. That is, it is possible to move to a processing that starts the subsequent tape process without performing any special operations.

### Application Example 2

The tape processing device according to the above-described application example preferably further includes a determining section that determines whether or not processing data relating to the tape process remains.

According to the application example, with the included determining section, it is possible to determine whether or not the processing data relating to the tape process remain and select whether or not to move to the next operation based on the determined result. That is, it is possible to determine to continue the processing and select the start of the next operation in a case in which the processing data relating to the tape process remains and to determine to finish the processing and finish the tape process in a case in which the processing data relating to the tape process does not remain.

### Application Example 3

The tape processing device according to the above-described application example preferably further includes a control section that controls the sending and processing section, the cutting section, the discharging section, the sensing section, and the determining section.

According to the application example, with the included control section, it is possible to perform the control of the next operation based on the determined result of the presence and absence of the processing tape in the sensing section or the determined result of whether or not the processing data relating to the tape process in the determining section remains. Accordingly, it is possible to provide a tape processing device capable of efficiently performing a tape process.

### Application Example 4

A tape processing method according to the application example includes a step of performing a tape process while sending processing tape, a step of cutting the tape-processed processing tape, a step of feeding and holding the cut processing tape, and a step of determining presence and absence of the held processing tape.

According to the tape processing method of the application example, it is possible to perform a tape process while sending the processing tape, that is, interlock (synchronize) the sending of the processing tape and the tape process, and thus it is possible to smoothly perform the pinching of the processing tape using the discharging section in the step of cutting the processing tape and suppress a tape jam.

In addition, the cut processing tape is held while being fed, the cut part of the processing tape (tape piece) is not flown in all direction, and it is possible to stabilize the discharging position.

In addition, the presence and absence of the held processing tape is determined, and thus it is possible to move to the next operation based on the determined result. That is, it is possible to move to a processing that starts the subsequent tape process without performing any special operations.

### Application Example 5

The tape processing method according to the above-described application example preferably further includes a step of determining whether or not processing data of the tape process remains and a step of commanding start of the subsequent tape process based on the determined result of whether or not the processing data remains.

According to the application example, it is possible to determine whether or not the processing data of the tape process remains and select whether or not to move to the next operation based on the determined result. That is, it is possible to determine to continue the processing and select the start of the next operation in a case in which the processing data of the tape process remains and determine to finish the processing and finish the tape process in a case in which the processing data of the tape process does not remain. That is, it is possible to perform a repetitive tape process even when a user does not provide a command every time.

### BRIEF DESCRIPTION OF DRAWINGS

FIG. 1 is an external perspective view of a tape printing device in a lid closing state according to an embodiment.

FIG. 2A is an external perspective view of the tape printing device in a lid opening state.

FIG. 2B is an enlarged view of a Q part of FIG. 2A.

FIG. 3 is a perspective view illustrating a tape cutting mechanism.

FIG. 4 is a control block diagram of the tape printing device.

FIG. 5 is a plan view illustrating a tape sending power system.

FIG. 6A is a perspective view illustrating a tape discharging mechanism seen from an upstream side in a tape sending direction.

FIG. 6B is a perspective view illustrating a tape discharging mechanism seen from a downstream side in a tape sending direction.

FIG. 7 is a disassembled oblique view of a vicinity of a driving roller portion in the tape discharging mechanism.

FIG. 8 is a disassembled oblique view of a vicinity of a driven roller portion in the tape discharging mechanism.

FIG. 9 is a disassembled oblique view of a vicinity of a movable holder in a driven roller portion.

FIG. 10A is a plan view illustrating a series of movement of a vicinity of the driven side rotating body at the time of opening the openable lid when opening and closing an openable lid and performing a sending operation of a printing tape.

FIG. 10B is a plan view of a state in which the printing tape is not present between the driving side rotating body and the driven side rotating body at the time of closing the openable lid.

FIG. 10C is a plan view of a state in which the printing tape is pinched between the driving side rotating body and the driven side rotating body at the time of closing the openable lid.

FIG. 11A is a plan view illustrating a series of movement of a vicinity of the discharge driving roller and the discharge driven roller at the time of opening the openable lid when opening and closing the openable lid and performing a sending operation of the printing tape.

FIG. 11B is a plan view of a state in which the printing tape is not present between the driving side rotating body and the driven side rotating body at the time of closing the openable lid.

FIG. 11C is a plan view of a state in which the printing tape is pinched between the driving side rotating body and the driven side rotating body at the time of closing the openable lid.

FIG. 12A is a front view illustrating the series of movement of the vicinity of the discharge driving roller and the discharge driven roller at the time of opening the openable lid when opening and closing the openable lid and performing the sending operation of the printing tape.

FIG. 12B is a front view of a state in which the printing tape is not present between the driving side rotating body and the driven side rotating body at the time of closing the openable lid.

FIG. 12C is a front view of a state in which the printing tape is pinched between the driving side rotating body and the driven side rotating body at the time of closing the openable lid.

FIG. 13A is a front view illustrating a series of movement of a vicinity of the discharge driving roller, the discharge driven roller, and a hook member at the time of opening the openable lid when opening and closing the openable lid and performing the sending operation of the printing tape.

FIG. 13B is a front view of a state in which the printing tape is not present between the driving side rotating body and the driven side rotating body at the time of closing the openable lid.

FIG. 13C is a front view of a state in which the printing tape is pinched between the driving side rotating body and the driven side rotating body at the time of closing the openable lid.

FIG. 14A is a front view illustrating a driving side rotating body and a driven side rotating body according to another embodiment, and a state in which the driving side rotating body and the driven side rotating body are engaged with each other.

FIG. 14B is a front view of a state in which the driving side rotating body and the driven side rotating body are engaged with each other.

FIG. 14C is a plan view of a state in which the driving side rotating body and the driven side rotating body are engaged with and detached from each other.

FIG. 14D is a front view of a state in which the driving side rotating body and the driven side rotating body are engaged with and detached from each other.

FIG. 15 is a flow chart illustrating an example of a tape processing method.

### DESCRIPTION OF EMBODIMENTS

Hereinafter, a tape processing device according to an embodiment of the invention will be described with reference to attached drawings. In the embodiment, a tape printing device will be exemplified as the tape processing device. After the tape printing device performs printing on a printing tape which is an object to be printed while sending the printing tape, cuts a printed part of the printing tape while half-cutting the printing tape, and discharges a tape piece (label) to the outside of the device. Also, in the embodiment, “front”, “rear”, “left”, “right”, “up”, and “down” follow a direction (seen from the front) seen from a user who uses the tape printing device.

(Tape Processing Device)

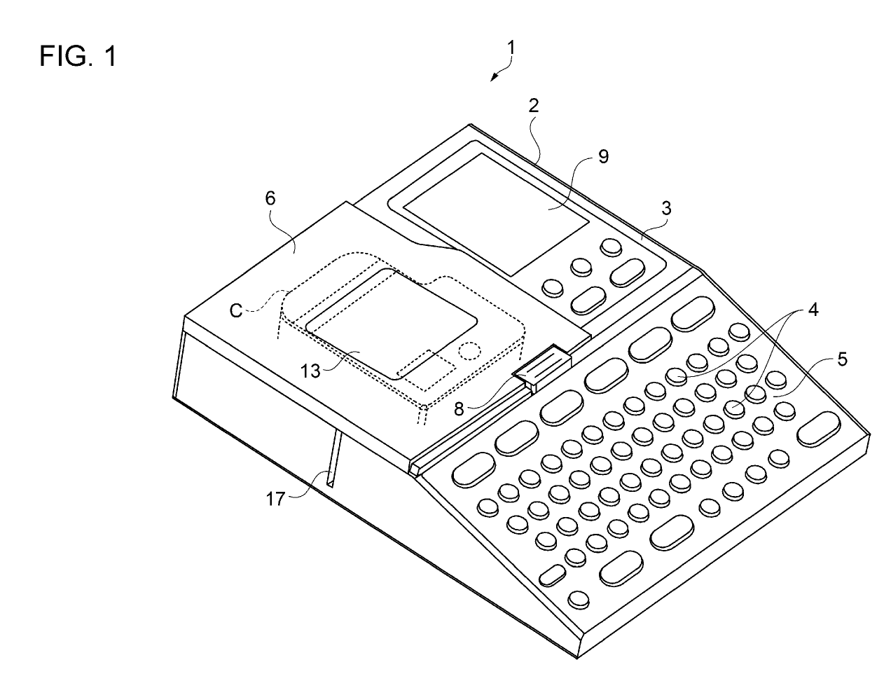

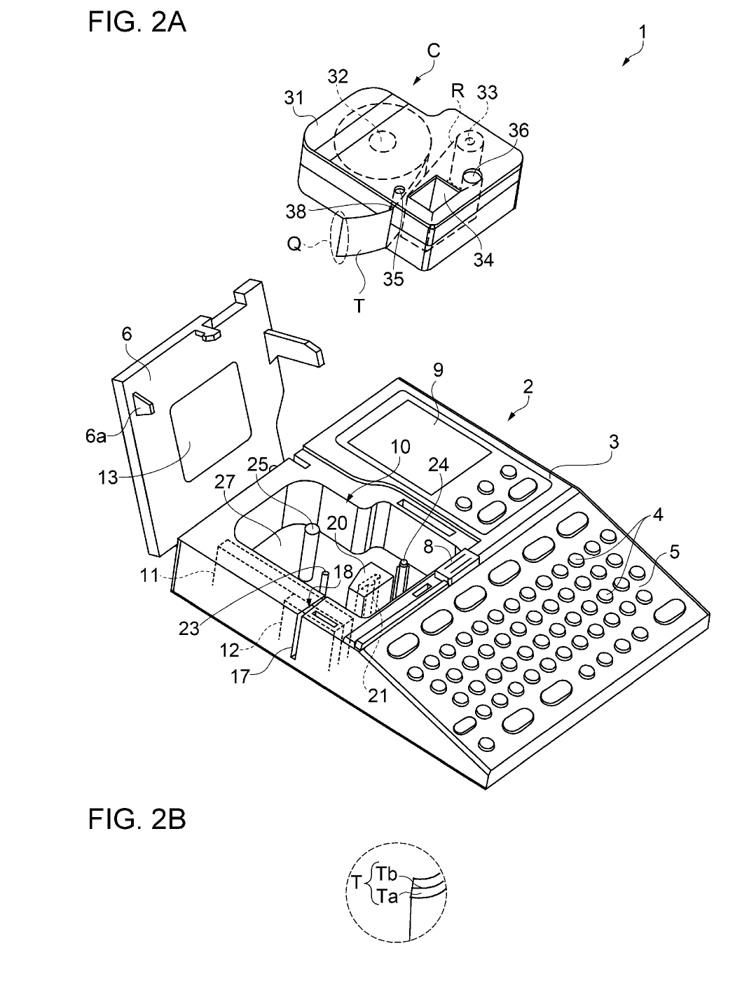

As illustrated in FIG. 1, FIG. 2A, and FIG. 2B, a tape printing device 1 as the tape processing device is provided with a device main body 2 which performs a printing process on a printing tape T, and a tape cartridge C which accommodates the printing tape T and an ink ribbon R and is detachable from the device main body 2. The printing tape T to which a release tape Tb which is an object to be printed is attached is accommodated so as to be capable of being fed in the tape cartridge C.

An outer shell as a device case 3 is formed in the device main body 2, and a keyboard 5 including various keys 4 is disposed on an upper surface of a front half portion of the device case 3. Meanwhile, an openable lid 6 is widely provided on a left upper surface of a rear half portion of the device case 3, and the openable lid 6 vertically opens and closes based on a hinge (illustration is omitted) provided on a rear end portion. A lid body opening button 8 which opens the lid is provided on a front side of the openable lid 6. Further, a rectangular display 9 for displaying an input result or the like from the keyboard 5 is disposed on a right upper surface of the rear half portion the device case 3.

When the lid body opening button 8 is pressed and the openable lid 6 opens, a cartridge mounting portion 10 where the tape cartridge C is detachably mounted is provided to be recessed inside thereof, and the tape cartridge C is detachably mounted in the cartridge mounting portion 10 in a state in which the openable lid 6 is opened. That is, the openable lid 6 opens and closes the cartridge mounting portion 10. In addition, an actuating protrusion 6a which protrudes to a lower surface of the left front portion and is engaged with a hook member 175 to be described later and an observation window 13 for visually recognizing mounting and non-mounting of the tape cartridge C in a state in which the cartridge mounting portion 10 is closed are formed on the openable lid 6.

A tape discharging opening 17 extending to the cartridge mounting portion 10 is formed on a left side portion of the device case 3, and a tape discharging passage 18 is provided between the cartridge mounting portion 10 and the tape discharging opening 17. Also, the tape cutting mechanism 11 which cuts the printing tape T from an upstream side and a tape discharging mechanism 12 which discharges the tape piece of the printing tape T after being cut from the tape discharging opening 17 are assembled and built in the device case 3 so as to face the tape discharging passage 18.

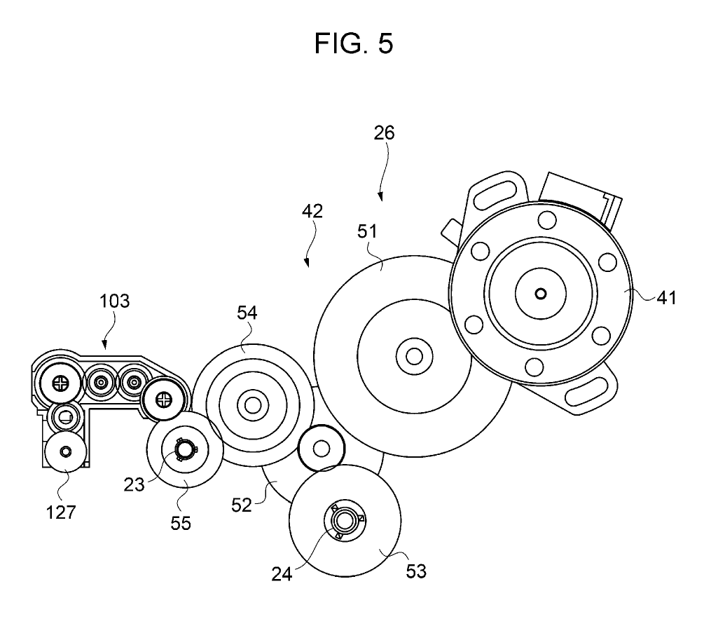

Meanwhile, a thermal type printing head 21 including a plurality of heating elements inside a head cover 20, a platen driving shaft 23 facing the printing head 21, a winding driving shaft 24 which winds the ink ribbon R, and a positioning protrusion 25 of a tape reel 32 to be described later are disposed on the cartridge mounting portion 10. The platen driving shaft 23 and the winding driving shaft 24 penetrate through a bottom plate 27 of the cartridge mounting portion 10, and a tape sending power system 26 (refer to FIG. 5) which is a power system for driving the platen driving shaft 23 and the winding driving shaft 24 is disposed in a lower space of the bottom plate 27.

The tape cartridge C accommodates the tape reel 32 which winds the printing tape T and a ribbon reel 33 in which the ink ribbon R is wound around a right lower position to be rotatable in an upper center portion inside a cartridge case 31, and the printing tape T and the ink ribbon R have the same width as each other. In addition, a through hole 34 being inserted into the head cover 20 which covers the printing head 21 is formed in a left lower portion of the tape reel 32. Further, a platen roller 35, which is rotated and driven by being fit to the platen driving shaft 23, is disposed in a vicinity of the through hole 34 to correspond to an overlapped part of the printing tape T and the ink ribbon R. Meanwhile, a ribbon winding reel 36 in which the winding driving shaft 24 is fit thereto so as to be rotated and driven is disposed close to the ribbon reel 33.

When the tape cartridge C is mounted in the cartridge mounting portion 10, the through hole 34 is inserted into the head cover 20, a center hole of the tape reel 32 is inserted into the positioning protrusion 25, a center hole of the platen roller 35 is inserted into the platen driving shaft 23, and a center hole of the ribbon winding reel 36 is inserted into the winding driving shaft 24. Because of rotating and driving of the platen driving shaft 23 and the winding driving shaft 24, the printing tape T is fed from the tape reel 32 and the ink ribbon R is fed from the ribbon reel 33 so as to overlap with the printing tape T at a part of the through hole 34 side by side, and then the printing tape T is sent from a tape delivery opening 38 which is formed on a side surface of the cartridge case 31 to the outside of the cartridge case 31, and the ink ribbon R is wound up by the ribbon winding reel 36. In addition, a so called a printing transmission, in which the platen roller 35 and the printing head 21 face each other with the printing tape and the ink ribbon pinched therebetween, is performed on a part where the printing tape T and the ink ribbon R are disposed side by side.

The printing tape T is constituted of a recording tape Ta in which an adhesive layer is formed on a rear surface and the release tape Tb which is adhered to the recording tape Ta using the adhesive layer. Also, the printing tape T is accommodated by being wound around the tape reel 32 with the recording tape Ta on the outside and with the release tape Tb on the inside. In addition, various tape types (a tape width, a background color, a background pattern, a material (texture), and the like of the printing tape T) of the printing tapes T are prepared, and the printing tapes are accommodated in the cartridge case 31 with the ink ribbon R. For example, the printing tapes T having various tape widths in a range of 4 mm to 36 mm are prepared, and the printing tapes having tape thicknesses in a range of 0.1 mm to 0.8 mm are prepared.

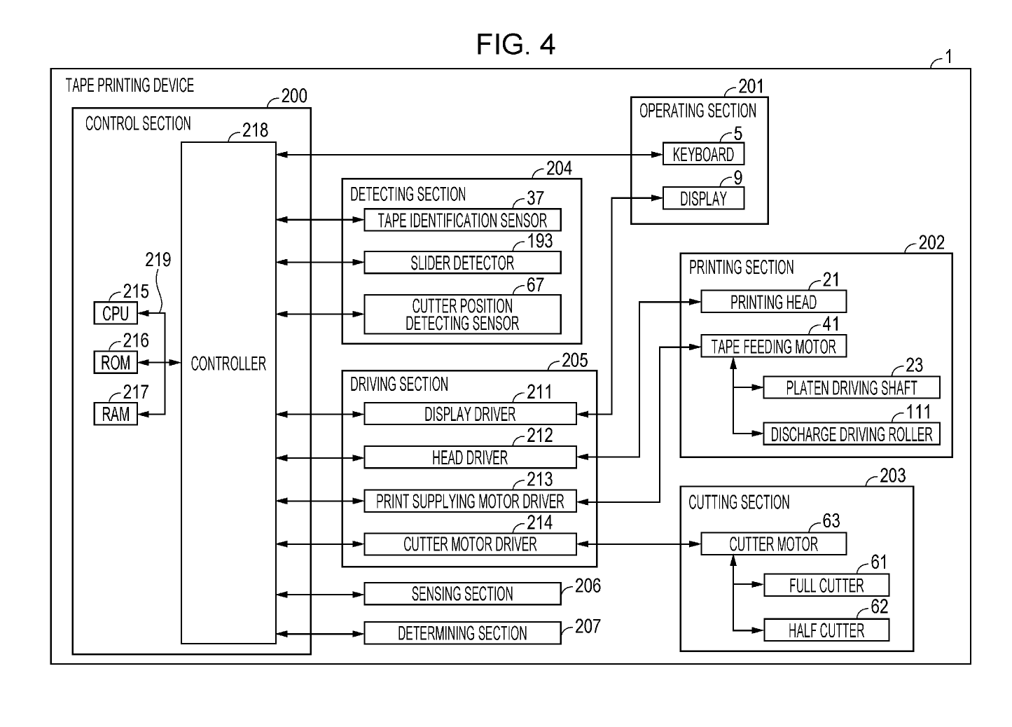

In addition, a plurality of holes (illustration is omitted) for specifying the types of the printing tape T is provided on a rear surface of the cartridge case 31. Meanwhile, a plurality of tape identification sensors 37 (refer to FIG. 4) such as a micro switch which detects bit patterns thereof is provided in the cartridge mounting portion 10 corresponding to the plurality of holes, and the tape types (particularly, the tape width) can be discriminated by detecting a state of the plurality of holes by the tape identification sensor 37.

When the tape cartridge C is mounted in the cartridge mounting portion 10, and the openable lid 6 is closed, the printing head 21 is rotated through a head release mechanism which is not illustrated, the printing tape T and the ink ribbon R are pinched between the printing head 21 and the platen roller 35, and the tape printing device 1 becomes a printing standby state.

After inputting and editing printing data, when a printing operation is commanded, the platen roller 35 is rotated and driven, and a desired printing is performed on the printing tape T by driving the printing head 21 while feeding the printing tape T from the tape cartridge C. With the printing operation, the ink ribbon R is wound up inside the tape cartridge C, and a printed part of the printing tape T is sent from the tape discharging opening 17 to the outside of the device.

When the printing is completed, the printing tape T is half-cut by the tape cutting mechanism 11, and a rear end portion of the printed part of the printing tape T is fully cut. “fully cut” disclosed here means a cutting process in which the entirety of the printing tape T, that is, the recording tape Ta and the release tape Tb are cut together, and the “half-cut” means a cutting process in which only the recording tape Ta is cut without cutting the release tape Tb. Also, as a half-cutting, only the release tape Tb may be cut.

Regarding a tape piece after being cut, only a distal end portion thereof is discharged from the tape discharging opening 17 by actuation of the tape discharging mechanism 12. In this manner, a label on which a desired character or the like is printed is creased.

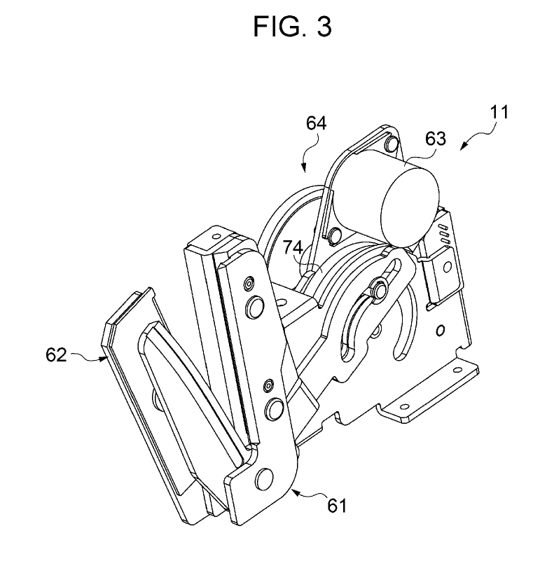

As illustrated in FIG. 3, the tape cutting mechanism 11 is provided with a scissor type full cutter 61 which fully cuts the printing tape T, a pressing type half cutter 62 which is provided on a downstream side of a full cutter 61 in a tape sending direction and half-cuts the printing tape T and, a cutter motor 63 which is constituted by a stepping motor and is a driving source of the full cutter 61 and the half cutter 62, a cutter power transmission mechanism 64 which transmits power of the cutter motor 63 to the full cutter 61 and the half cutter 62, and a cutter position detecting sensor 67 (refer to FIG. 4) which is disposed to face a certain position on a circumferential surface of a crank disk 74 constituting the cutter power transmission mechanism 64 and detects an initial position of the crank disk 74. Also, the full cutter 61 performs a cutting operation when the crank disk 74 is rotated in a forward direction from the initial position and then is rotated in a reverse direction so as to return to the initial position, the half cutter 62 performs the cutting operation when the crank disk 74 is rotated in a reverse direction from the initial position and then is rotated in a forward direction so as to return to the initial position.

With reference to FIG. 4, a control system of the tape printing device 1 will be described. The tape printing device 1 is provided with an operating section 201, a printing section 202 as a sending and processing section, a cutting section 203, and a detecting section 204. In addition, the tape printing device 1 is further provided with a driving section 205 including a display driver 211 which drives the display 9, a head driver 212 which drives the printing head 21, a print supplying motor driver 213 which drives the tape sending motor 41, and a cutter motor driver 214 which drives the cutter motor 63. Also, a control section 200 which is connected to each section and controls the entirety of the tape printing device 1 is included.

The operating section 201 includes the keyboard 5 and the display 9, and functions as an interface of a user for inputting information of characters from the keyboard 5 or displaying various information items on the display 9.

The printing section 202 as the sending and processing section includes the tape sending motor 41 for rotating the platen roller 35 and a discharge driving roller 111 to be described later and the printing head 21, and sends the printing tape T when the platen roller 35 is rotated by driving the tape sending motor 41. Further, the printing head 21 is driven based on the input information relating to characters, and printing is performed on the printing tape T being sent. In addition, the printing section 202 discharges the printing tape T when the discharge driving roller 111 is rotated by driving the tape sending motor 41.

The cutting section 203 includes the cutter motor 63 for operating the full cutter 61 and the half cutter 62, and when the cutter motor 63 is driven, the full cutter 61 and the half cutter 62 perform full cutting or half cutting on the printing tape T after being printed.

The detecting section 204 includes the tape identification sensor 37, the cutter position detecting sensor 67, and a slider detector 193 to be described later, detects a tape type, a position of a cutter, and whether or not the printing tape T is present, and outputs each detected result to the control section 200.

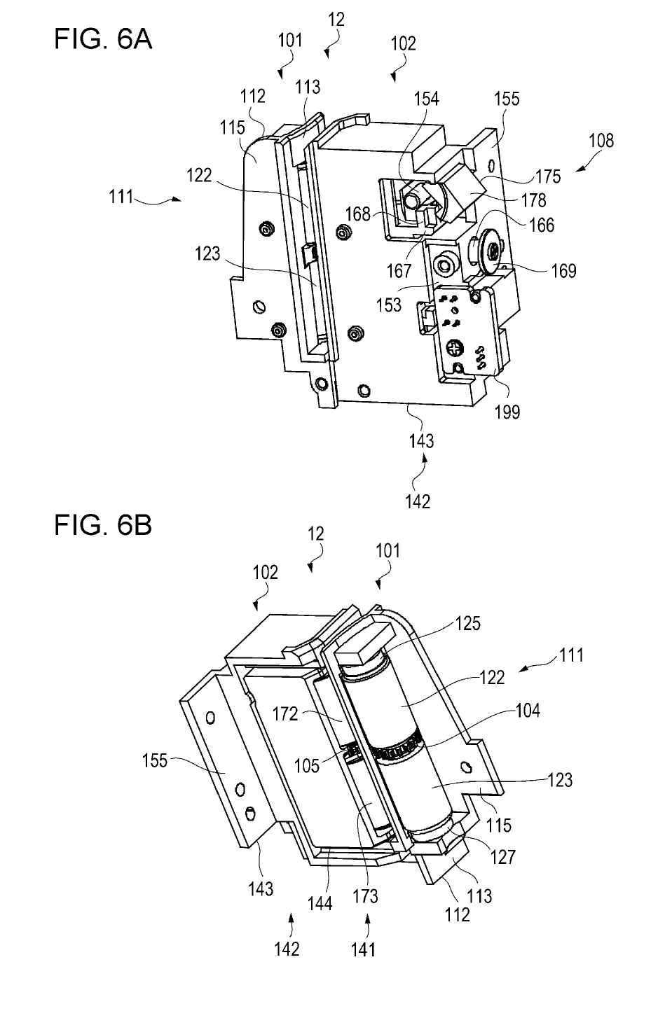

The sensing section 206 is provided with a photo sensor (illustration is omitted) or the like. The sensing section 206 determines whether or not the printing tape T cut by the cutting section 203 is pinched and held between the discharge driving roller 111 and the discharge driven roller 141 (refer to FIGS. 6A and 6B) constituting the tape discharging mechanism 12, and outputs the determined result to the control section 200 (controller 218).

The determining section 207 determines whether or not data relating to tape process which is set in advance by a user, for example, the number of repetitive printings (the number of sheet being printed) or another printing pattern remains, and outputs the determined result to the control section 200 (controller 218).

The control section 200 is provided with a central processing unit (CPU) 215, a read only memory (ROM) 216, a random access memory (RAM) 217, and the controller (input output controller (IOC)) 218, and these components are connected to each other through an inner bus 219. Also, the CPU 215 inputs various signals and data items from each section inside the tape printing device 1 through the controller 218 in accordance with a control program of the ROM 216. In addition, the CPU processes various data items inside the RAM 217 based on the input various signals and data items, and outputs various signal data to each section inside the tape printing device 1 through the controller 218. Accordingly, for example, the control section 200 controls the printing process or the cutting process based on the detected result of the detecting section 204. In addition, the control section 200 selects whether or not a procedure proceeds to a next printing operation, for example, based on a determined result of presence or absence of the cut printing tape T detected by the sensing section 206, or a determined result of remaining of the data relating to tape process, which is set in advance by a user, detected by a determining section 207, such as the number of repetitive printings (the number of sheet being printed) or another printing pattern.

As illustrated in FIG. 5, the tape sending power system 26 includes the tape sending motor 41 which is a power source, and a sending power transmission mechanism 42 which transmits power of the tape sending motor 41 to the platen driving shaft 23 and the winding driving shaft 24. That is, the tape sending motor 41 is used as a power source of the platen driving shaft 23 and the winding driving shaft 24. Also, detail description will be described later, but regarding the discharge driving roller 111 of the tape discharging mechanism 12, the tape sending motor 41 is also set as a power source.

The sending power transmission mechanism 42 is provided with an input gear 51 which meshes with a gear formed on a main shaft of the tape sending motor 41, the branch gear 52 which branches the power to both the platen driving shaft 23 side and the winding driving shaft 24 side while meshing with the input gear 51, a first output gear 53 which meshes with the branch gear 52 and is turnably attached to the winding driving shaft 24 so as to be rotated, a relay gear 54 which meshes with the branch gear 52, and a second output gear 55 which meshes with the relay gear 54 and is turnably attached to the platen roller 35 so as to be rotated. When the tape sending motor 41 is driven, through each gear, the platen driving shaft 23 and the winding driving shaft 24 are rotated. Accordingly, when the printing tape T is sent, winding of the ink ribbon R is performed by synchronizing with a tape sending.

With reference to FIGS. 6A, 6B, and 7 to 9, the tape discharging mechanism 12 as a discharging section will be described. As illustrated in FIGS. 6A and 6B, the tape discharging mechanism 12 as the discharging section sends and discharges the printing tape T so as to be rotatable by a nip roller (sending roller) constituted of the discharge driving roller 111 (first roller) which is one of discharging rollers and is turnably connected with the release tape Tb side of the printing tape T, and the discharge driven roller 141 (second roller) which is another of the discharging rollers and is turnably connected with the recording tape Ta side.

The tape discharging mechanism 12 is provided with the driving roller portion 101 including the discharge driving roller 111, the driven roller portion 102 including the discharge driven roller 141 facing the discharge driving roller 111, and a discharging power transmission mechanism (sending and interlocking section) 103 (refer to FIG. 5) which transmits a rotation power of the tape sending motor 41, which is power-branched from the sending power transmission mechanism 42 described above, to the discharge driving roller 111.

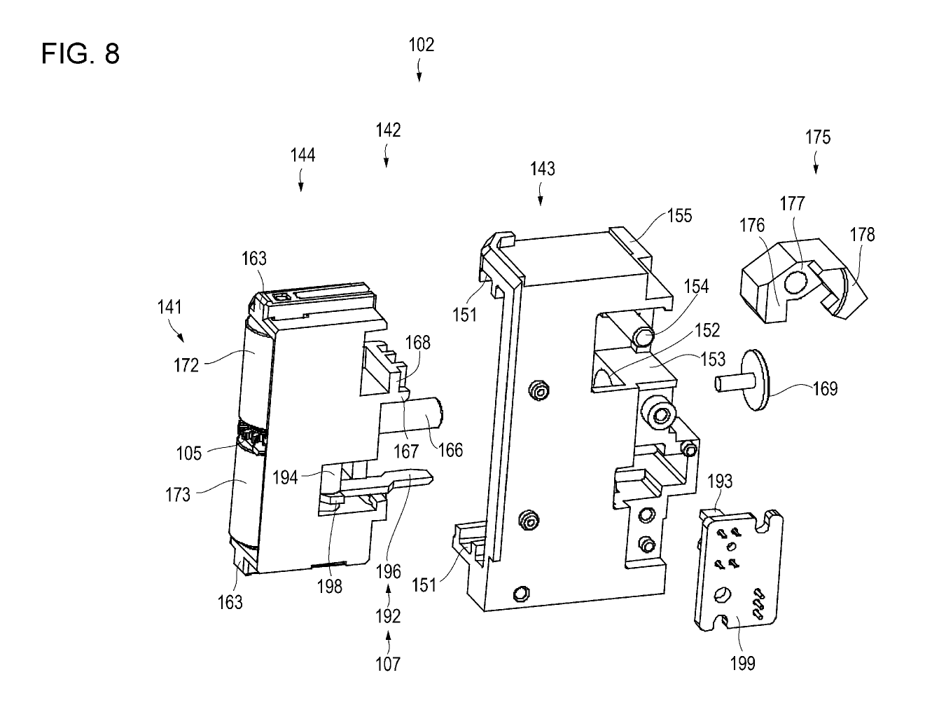

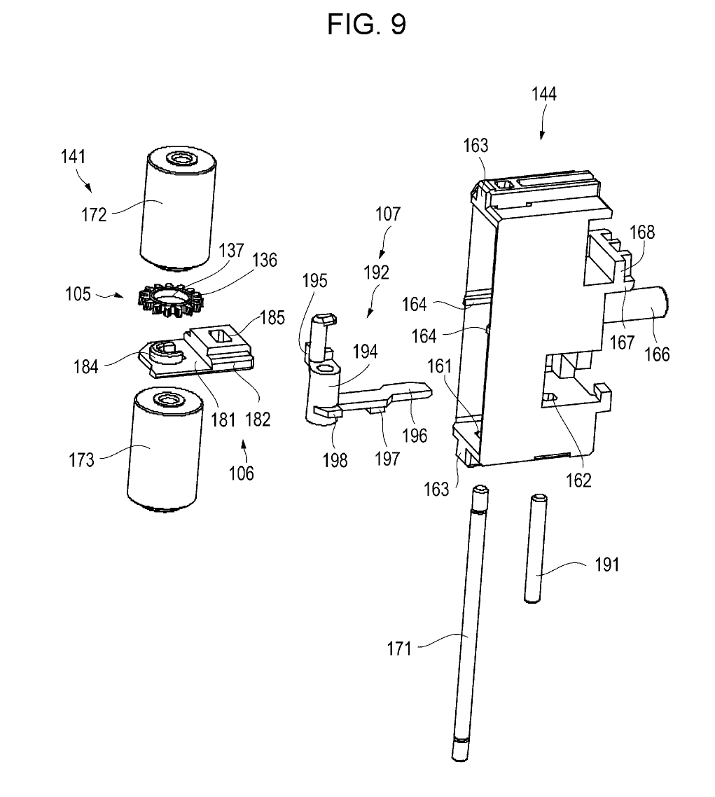

In addition, the tape discharging mechanism 12 is provided with the driving side rotating body 104 and the driven side rotating body 105 which are respectively formed in a gear shape and engaged with each other in a state of being overlapped with each other, a rotating body slider 106 which supports the driven side rotating body 105 and is configured to be slidable so that the driven side rotating body 105 is disengaged from the driving side rotating body 104, a detecting mechanism 107 (refer to FIGS. 8 and 9) which detects the rotating body slider 106 slid to one moving end, and a separating and contacting mechanism 108 which separates and brings the discharge driven roller 141 from and into contact with the discharge driving roller 111 interlocking with opening and closing of the openable lid 6.

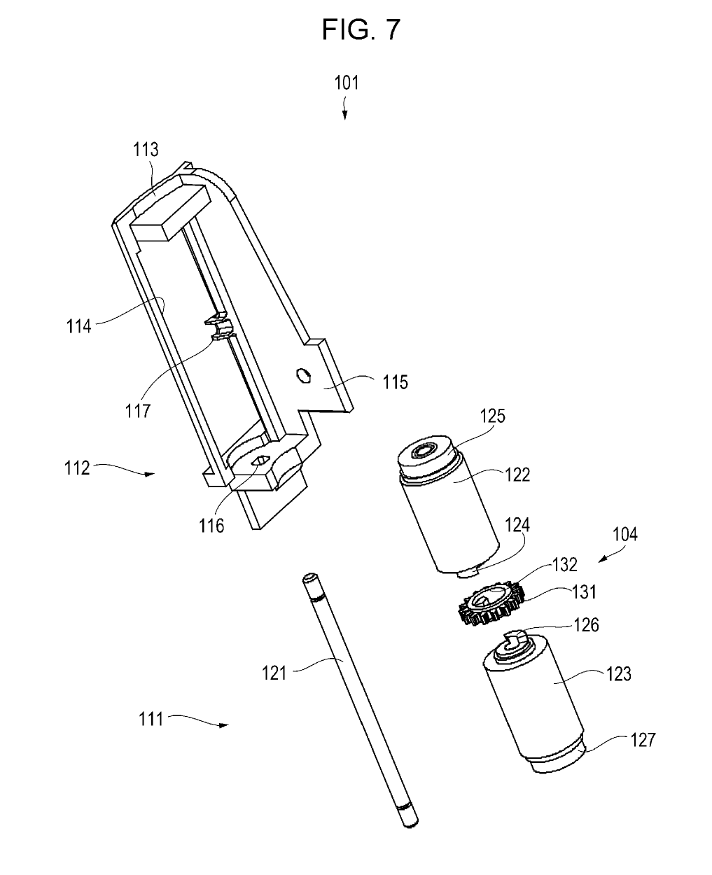

As illustrated in FIG. 7, the driving roller portion 101 is provided with the discharge driving roller 111, and a driving roller holder 112 which holds the discharge driving roller 111 and the driving side rotating body 104 so as to be rotatable.

The driving roller holder 112 is constituted of an opening forming piece 113 in which a substantially rectangular driving roller opening 114 is formed to be opposite to the driven roller portion 102, and a driving side mounting piece 115 which is vertically arranged backwardly from an outer edge of a downstream side of the driving roller opening 114 in a tape sending direction and is installed in a base frame (illustration is omitted). A pair of driving roller bearings 116 is formed on an upper and lower outer sides of the driving roller opening 114. The discharge driving roller 111 and the driving side rotating body 104 are supported so as to be rotatable by the pair of driving roller bearings 116, and slightly protrude from the driving roller opening 114 toward the driven roller portion 102 side. In addition, in the driving roller opening 114, a rotating body receiving section 117, where a periphery of the driving side rotating body 104 is positioned, protrudes in a substantially “C” character shape so as to face the inside of the driving roller opening 114 in a vertically intermediate part of an edge on the downstream side in the tape sending direction.

The discharge driving roller 111 is provided with a driving roller shaft 121 in which upper and lower end portions are supported by the pair of driving roller bearings 116, and a driving side upper roller main body 122 and a driving side lower roller main body 123 which are pivotally supported so as to be rotatable by the driving roller shaft 121.

An upper roller fitting protruding portion 124 which is fit to a driving side rotating body hole 132 (to be described later) of the driving side rotating body 104 is formed on a lower end portion of the driving side upper roller main body 122. Meanwhile, an upper roller gear portion 125 is formed on an upper end portion of the driving side upper roller main body 122.

In addition, the driving side lower roller main body 123 is formed in the same manner as the driving side upper roller main body 122, and a lower roller fitting protruding portion 126 which is fit to the driving side rotating body hole 132 of the driving side rotating body 104 is formed on the upper end portion, a lower roller gear portion 127 is formed on the lower end portion, and a downstream end of the discharging power transmission mechanism 103 as the sending and interlocking section meshes with the lower roller gear portion 127.

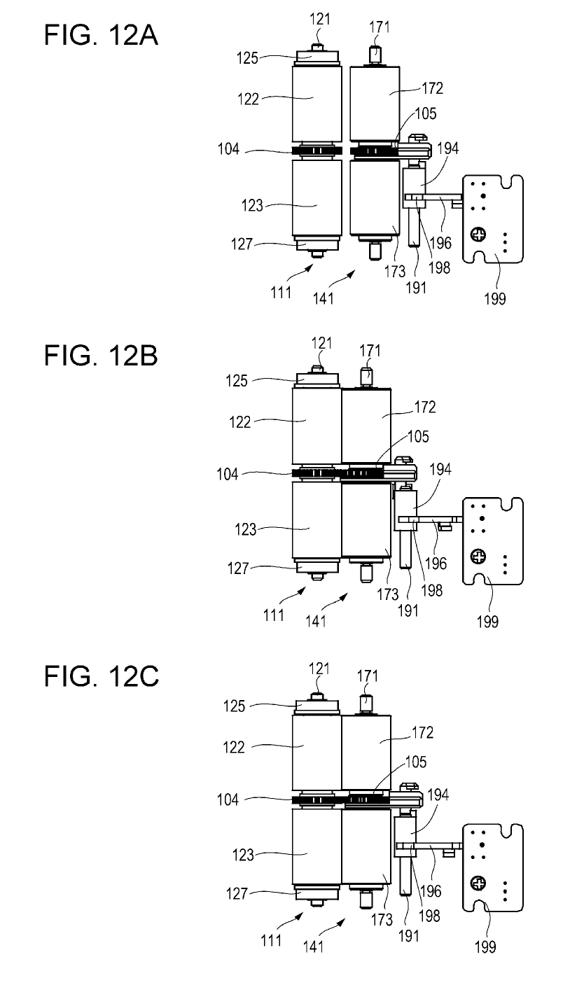

As illustrated in FIG. 7, the driving side rotating body 104 is turnably attached to the driving roller shaft 121, and is provided between the driving side upper roller main body 122 and the driving side lower roller main body 123. In the driving side rotating body 104, a driving side rotating body tooth portion 131 (first unevenness portion) which is an unevenness part having a gear tooth shape is provided in a circumferential direction of an outer circumferential surface, and the driving side rotating body hole 132 with which the upper roller fitting protruding portion 124 and the lower roller fitting protruding portion 126 are respectively fit and to which the driving roller shaft 121 is inserted is formed in the center portion. The driving side rotating body 104 is formed to have the same diameter as that of the driving side upper roller main body 122 and the driving side lower roller main body 123 of the discharge driving roller 111, and in a state of being turnably attached to the driving roller shaft 121, does not include a projection in a diameter direction with respect to the driving side upper roller main body 122 and the driving side lower roller main body 123 (refer to FIGS. 12A to 12C).

Also, when the upper roller fitting protruding portion 124 and the lower roller fitting protruding portion 126 are respectively fit to the driving side rotating body hole 132, the driving side upper roller main body 122, the driving side lower roller main body 123, and the driving side rotating body 104 are integrally and pivotally supported by the driving roller shaft 121. Also, when the rotation power of the tape sending motor 41 is transmitted to the lower roller gear portion 127 through the discharging power transmission mechanism (sending and interlocking section) 103, the driving side upper roller main body 122, the driving side lower roller main body 123, and the driving side rotating body 104 are integrally rotated. Also, regardless of the tape width, the printing tape T is sent so that the driving side rotating body 104 and the driven side rotating body 105 are positioned in a substantially intermediate portion in a width direction.

As illustrated in FIG. 8, the driven roller portion 102 is provided with the discharge driven roller 141, and a driven roller holder 142 which holds the discharge driven roller 141 and the driven side rotating body 105 so as to be rotatable.

The driven roller holder 142 is provided with a fixing holder 143 fixed to the base frame, and a movable holder 144 which supports the discharge driven roller 141 so as to be rotatable and in which the discharge driven roller 141 is slidably accommodated in the fixing holder 143 so as to be separated from and come into contact with the discharge driving roller 111.

The fixing holder 143 is formed in a box shape in which a surface facing the driving roller portion 101 and a surface on an upstream side in the tape sending direction are opened, and is constituted of a pair of upper and lower guide grooves 151 which is respectively formed on a lower surface of an upper wall portion and an upper surface of a lower wall portion, and guides a slide of the movable holder 144, a guide block 153 which is provided in a substantially intermediate portion in a vertical direction in an end portion opposite to the driving roller portion 101 and in which a circular guide hole 152 for guiding a slide rod 166 of the movable holder 144 is formed, a hook spindle 154 which protrudes to the downstream side in the tape sending direction on an upper side of the guide block 153 and pivotally supports the hook member 175 to be described later so as to be rotatable, and a driven side attachment piece 155 which extends from an opening edge of an upstream side in the tape sending direction and is attached to the base frame (illustration is omitted). Further, illustration is omitted; however, an interlocking and engaging receiving portion with which an interlocking and engaging portion 198 to be described later is engaged is formed on a lower side inner surface of a side wall portion of the fixing holder 143.

As illustrated in FIG. 9, the movable holder 144 is formed in a box shape in which a surface facing the driving roller portion 101 opens, a pair of upper and lower driven roller bearings 161 which supports a driven roller shaft 171 (to be described later) is formed in an end portion of the driving roller portion 101 side on a lower surface of an upper wall portion and an upper surface of a lower wall portion, and a rotating body bearing 162 which supports a lower end of a rotation member spindle 191 (to be described later) is formed on an opposite side to the driving roller portion 101 side with respect to the driven roller bearing 161 on a lower side on the upper surface of the lower wall portion.

The movable holder 144 is provided with a pair of upper and lower guide ribs 163 which is formed on an upper surface of the upper wall portion and a lower surface of the lower wall portion and is respectively engaged with the guide groove 151, a pair of slide guides 164 which extends in a front/rear direction in a substantially intermediate portion in a vertical direction of an inner side surface on an upstream side and an inner side surface of a downstream side in the tape sending direction and guides a slide of the rotating body slider 106, a spring receiving portion (illustration is omitted) which faces the guide block 153 of the fixing holder 143 and with which one end of a returning spring (illustration is omitted) to be described later comes into contact, a slide rod 166 which protrudes to an opposite side (front side) to the driving roller portion 101 from the spring receiving portion and penetrates through the guide hole 152 of the fixing holder 143, a horizontal portion 167 which is formed to be connected with a side surface on the upstream side and a side surface on the downstream side in the tape sending direction on an upper side of the slide rod 166, and a holder engagement receiving portion 168 which protrudes to an upper surface of an end portion on an opposite side to the driving roller portion 101 of the horizontal portion 167, and with which the hook member 175 is engaged. In addition, a locking pin 169 which functions as a lock from the guide hole 152 of the slide rod 166 is screwed with on a distal end of the slide rod 166.

The discharge driven roller 141 is provided with the driven roller shaft 171 in which the upper and lower end portions supported by the pair of driven roller bearings 161, and a driven side upper roller main body 172 and a driven side lower roller main body 173 which are pivotally supported by the driven roller shaft 171 so as to be rotatable, and is rotated to be incidental to rotation of the discharge driving roller 111.

The driven side rotating body 105 is supported so as to be rotatable in a vicinity of the driven roller shaft 171, and is provided between the driven side upper roller main body 172 and the driven side lower roller main body 173 with the rotating body slider 106 supporting the driven side rotating body. In the driven side rotating body 105, a driven side rotating body tooth portion 136 (second unevenness portion) is formed in a gear tooth shape which is an unevenness on an outer circumferential surface in a circumferential direction, and a circular driven side rotating body hole 137 through which the driven roller shaft 171 loosely penetrates is formed. The driven side rotating body 105 is formed to have the substantially same diameter as that of the driven side upper roller main body 172 and the driven side lower roller main body 173 of the discharge driven roller 141, and in a state in which the rotating body slider 106 moves to a retracting position (details to be described later), there is no projection in a radial direction with respect to the driven side upper roller main body 172 and the driven side lower roller main body 173 (refer to FIGS. 12A to 12C).

The driven side rotating body tooth portion 136 is formed in a complementary shape to the driving side rotating body tooth portion 131, and is configured that the driving side rotating body 104 and the driven side rotating body 105 are capable of meshing. In a state in which the printing tape T is not present between the driving side rotating body 104 and the driven side rotating body, the driven side rotating body 105 is engaged with the driving side rotating body 104 in an overlapped state, and is rotated incidental to rotation of the driving side rotating body 104. When the printing tape T is pinched between the driving side rotating body 104 and the driven side rotating body 105, the driven side rotating body 105 is engaged with and detached from the driving side rotating body 104. Also, a width of overlapped part of the driving side rotating body 104 and the driven side rotating body 105 is, for example, approximately several mm.

The separating and contacting mechanism 108 interlocks with closing of the openable lid 6 so as to move the discharge driven roller 141 to a nip position where the printing tape T can be pinched between the discharge driving roller 111 and the discharge driven roller with respect to the discharge driving roller 111, and interlocks with opening of the openable lid 6 so as to move the discharge driven roller 141 to a separation position separated from the discharge driving roller 111. The separating and contacting mechanism 108 is provided with the hook member 175 which is configured to be rotatable based on the hook spindle 154 of the fixing holder 143, and the returning spring (not illustrated) which is fit onto the slide rod 166 of the movable holder 144. Regarding the returning spring, one end is in contact with the spring receiving portion of the movable holder 144, the other end is in contact with the guide block 153 of the fixing holder 143, and the movable holder 144 is urged to the driving roller portion 101 side with respect to the fixing holder 143.

As illustrated in FIG. 8, in the hook member 175, a hook engaging portion 176 which is engaged with the holder engagement receiving portion 168 of the fixing holder 143, a shaft hole forming portion 177 which is continuously curved from the hook engaging portion 176 and includes a shaft hole through which the hook spindle 154 penetrates formed on a substantially center portion, and a protrusion receiving portion 178 which is continuously curved from the shaft hole forming portion 177 and is engaged with the actuating protrusion 6a with the openable lid 6 formed therein. In addition, it is not illustrated, but an engaging spring (torsion coil spring) which is rotated and urged in a direction where the hook engaging portion 176 engages the hook member 175 with the holder engagement receiving portion 168 is built in the hook spindle 154.

When the openable lid 6 opens so that the actuating protrusion 6a is engaged with and detached from the protrusion receiving portion 178, the hook member 175 is urged to the engaging spring, and is rotated in a direction where the hook engaging portion 176 is engaged with the holder engagement receiving portion 168. As a result, the discharge driven roller 141 is moved to the separation position against the returning spring. Meanwhile, when the openable lid 6 is closed so that the actuating protrusion 6a is engaged with the protrusion receiving portion 178, the hook engaging portion 176 is rotated in a direction where the hook engaging portion is engaged with and detached from the holder engagement receiving portion 168 against the engaging spring. As a result, the discharge driven roller 141 returns to the nip position by the returning spring.

As seen from the above, the discharge driven roller 141 moves to the separation position by interlocking with opening of the openable lid 6, and a gap between the discharge driving roller 111 and the discharge driven roller 141 becomes wide. Therefore, when the tape cartridge C is set in the cartridge mounting portion 10, even in a case in which the printing tape T projects from the tape delivery opening 38, the tape cartridge C can be set so that the printing tape T reliably enters between the discharge driving roller 111 and the discharge driven roller 141. Also, when the openable lid 6 is closed after the tape cartridge C is set to the cartridge mounting portion 10, the discharge driven roller 141 moves to the nip position by interlocking with the closing, and thus the printing tape T can be rotated and sent by the discharge driving roller 111 and the discharge driven roller 141.

Also, since a rotating body 192 to be described later is also supported by the movable holder 144 with the discharge driven roller 141, the rotating body reciprocates by interlocking with opening and closing of the openable lid 6 using the separating and contacting mechanism 108.

The rotating body slider 106 is formed in a substantially rectangular shape in a plan view, and is constituted of a rotating body supporting portion 181 which supports the driven side rotating body 105 so as to be rotatable in a half portion of the driving roller portion 101 side, and a rotating body engaging portion 182 which is formed to be thicker than the rotating body supporting portion 181 in a half portion of an opposite side to the driving roller portion 101 side.

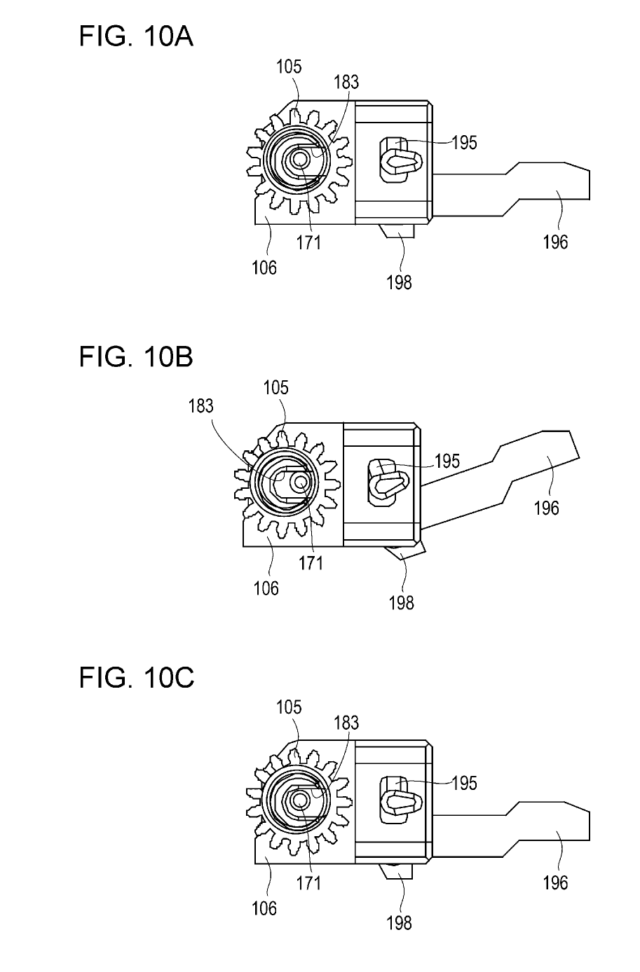

A long hole 183 (refer to FIGS. 10A to 10C) extending in a slide direction of the rotating body slider 106 is formed in the rotating body supporting portion 181, the driven roller shaft 171 is inserted into the long hole 183, and the rotating body slider 106 is slidable with respect to the discharge driven roller 141. In addition, on an upper surface of the rotating body supporting portion 181, a supporting protruding portion 184 protrudes along an outer edge of a circular arc portion on the driving roller portion 101 side of the long hole 183, the supporting protruding portion 184 is engaged with the driven side rotating body hole 137 of the driven side rotating body 105, and thus the driven side rotating body 105 is supported so as to be rotatable in a vicinity of the driven roller shaft 171. Meanwhile, an engaging hole 185 with which an engaging arm 195 of the rotating body 192 to be described later is engaged is formed in the rotating body engaging portion 182.

Also, the rotating body slider 106 is guided by the slide guide 164 described above so as to slide between an advance position where the driven side rotating body 105 supported thereby is engaged with the driving side rotating body 104 and a retracting position where the driven side rotating body 105 is engaged with and detached from the driving side rotating body 104.

The detecting mechanism 107 is provided with the rotation member spindle 191 in which a lower end is supported by the rotating body bearing 162 formed in the movable holder 144, the rotating body 192 which is supported so as to be rotatable by the rotation member spindle 191, and the slider detector 193 which is installed in a vicinity of a lower side of the guide block 153 of the fixing holder 143 through a substantially rectangular mounting substrate 199. Further, the detecting mechanism 107 is provided with a rotation urging spring (illustration is omitted) which urges rotation of the engaging arm 195 (to be described later) which is engaged with the rotating body slider 106 toward a direction where the rotating body slider 106 slides to the advance position.

The rotating body 192 is provided with a cylindrical shaft portion 194 into which the rotation member spindle 191 is inserted, the engaging arm 195 which includes an engaging portion engaged with the engaging hole 185 from an upper end portion of the shaft portion 194 in the radial direction, and an detecting arm 196 which extends in the radial direction so as to be substantially orthogonal to the engaging arm 195 from a lower end portion of the shaft portion 194 and in which a distal end portion (detected section) faces the slider detector 193. The detecting arm 196 is formed to be longer than the engaging arm 195.

The rotating body 192 rotates by interlocking with sliding of the rotating body slider 106 between the advance position and the retracting position thereof, when the engaging arm 195 is engaged with the engaging hole 185 of the rotating body slider 106. The engaging arm 195 and the detecting arm 196 of the rotating body 192 reciprocate based on the shaft portion 194 (rotation member spindle 191) by interlocking with the sliding of the rotating body slider 106 between the advance position and the retracting position thereof. That is, the shaft portion 194 converts rotation in a front/rear direction of the engaging arm 195 to rotation in a right and left direction of the detecting arm 196, but a swing amplitude of rotation of the detecting arm 196 is several times a swing amplitude of the engaging arm 195 as the detecting arm 196 is longer than the engaging arm 195. Also, hereinafter, a rotating direction of the engaging arm 195 and the detecting arm 196 in a case in which the rotating body slider 106 slides from the advance position to the retracting position is referred to as a retract rotating direction, and a rotating direction of the engaging arm 195 and the detecting arm 196 in a case in which the rotating body slider 106 slides from the retracting position to the advance position is referred to as an advance rotating direction.

In the detecting arm 196, a latching portion 197 in which one end of the rotation urging spring stops in the engaged state is formed on a lower surface of a curved portion which is curved in a crank shape in a substantially intermediate portion thereof in a plan view. The rotation urging spring is constituted of a torsion coil spring, is wound around the rotation member spindle 191, and one end thereof stops in the engaged state with the latching portion 197 and the other end stops in the engaged state with the inside of the fixing holder 143. The rotation urging spring urges the engaging arm 195 toward the advance rotating direction. That is, the rotation urging spring urges the rotating body slider 106 toward the advance position through the engaging arm 195.

Further, the interlocking and engaging portion 198 which protrudes in an opposite side to an extending direction of the engaging arm 195 is formed in a vicinity of a base of the detecting arm 196 in the shaft portion 194 of the rotating body 192. The rotating body 192 is supported by the movable holder 144 with the discharge driven roller 141, moves to an engaging position so as to be engaged with the interlocking and engaging receiving portion formed inside the fixing holder 143 by interlocking with movement from the nip position to the separation position of the discharge driven roller 141, and moves to a disengaging position so as to be engaged with and detached from the interlocking and engaging receiving portion by interlocking with movement from the separation position to the nip position of the discharge driven roller 141.

When the interlocking and engaging portion 198 is engaged with the interlocking and engaging receiving portion, the engaging arm 195 is rotated in the retract rotating direction against the rotation urging spring, and the rotating body slider 106 moves to the retracting position with respect to the discharge driven roller 141. When the interlocking and engaging portion 198 is engaged with and detached from the interlocking and engaging receiving portion, the engaging arm 195 is rotated in the advance rotating direction so as to be urged by the rotation urging spring, and the rotating body slider 106 moves to the advance position with respect to the discharge driven roller 141.

The slider detector 193 is constituted of a transmission type optical sensor (photo interrupter), and is disposed to face a distal end portion of the detecting arm 196 which is rotated by a rotating end in the retract rotating direction. The slider detector 193 detects that, when the distal end portion of the detecting arm 196 is inserted into between a light emitting element and a light receiving element which are disposed to face each other, the light thereof is blocked, and the rotating body slider 106 slid to the retracting position.

Also, the slider detector 193 may be constituted of a contact type center, but in a case in which a slider detector is constituted of a non-contact type sensor like the embodiment, since it is not necessary to work a pressing force on a contact point of the sensor when the rotating body slider 106 moves to the retracting position as a case in which the slider detector constituted of the contact type sensor, the rotating body slider 106 can be moved by a force as lightly as possible, and thus the printing tape T can be detected even when the printing tape is thin.

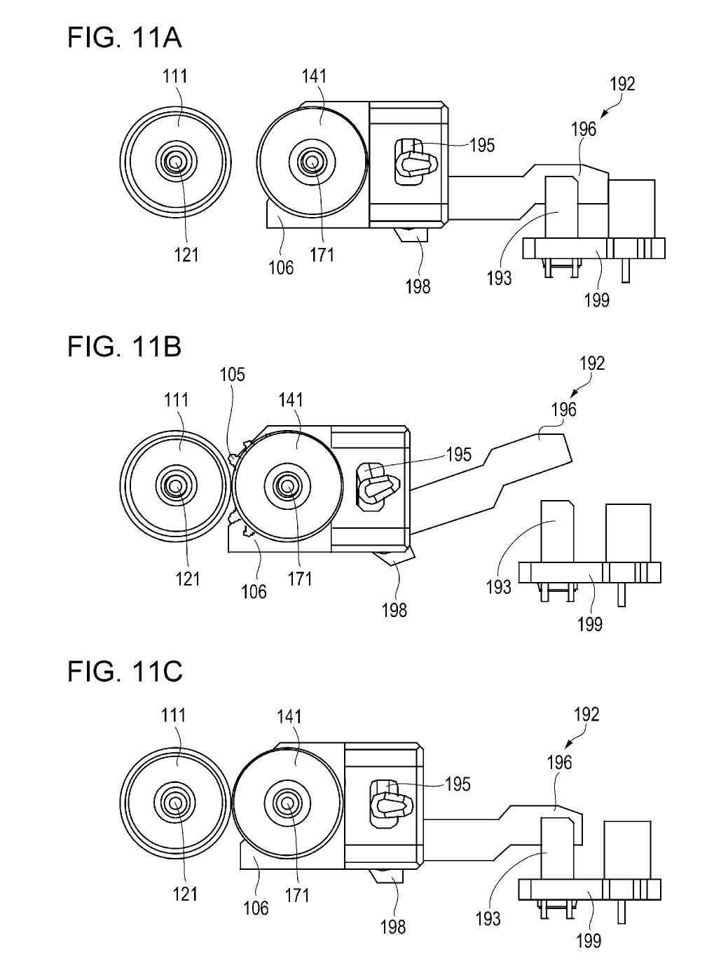

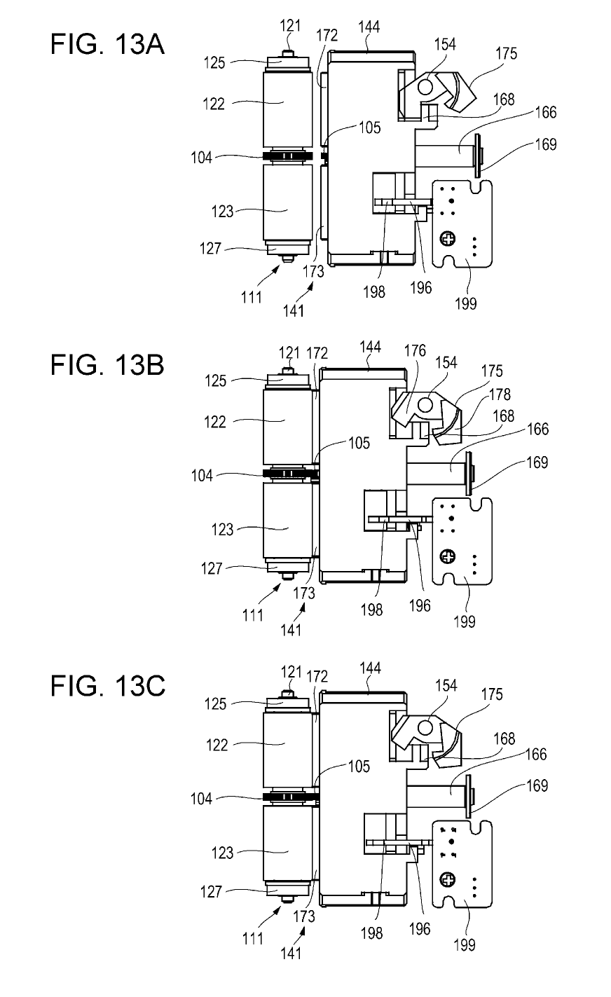

With reference to FIGS. 10A to 13C, a series of movement in a vicinity of the tape discharging mechanism 12 at the time of opening and closing the openable lid 6 and at the time of performing the sending operation (discharging operation) of the printing tape T will be described.

As illustrated in FIGS. 10A, 11A, 12A, and 13A, when the openable lid 6 opens, the actuating protrusion 6a of the openable lid 6 is engaged with and detached from the protrusion receiving portion 178 of the hook member 175, and the hook engaging portion 176 of the hook member 175 is engaged with the holder engagement receiving portion 168. As a result, the discharge driving roller 111 moves from the nip position to the separation position, and the rotating body 192 moves from the disengaging position to the engaging position. Since the driven side rotating body 105 supported in a vicinity of the driven roller shaft 171 is also separated from the driving side rotating body 104 in conjunction with movement to the separation position of the discharge driving roller 111, an interval between the driving side rotating body 104 and the driven side rotating body 105 becomes wide.

Further, the interlocking and engaging portion 198 is engaged with the interlocking and engaging receiving portion in conjunction with movement to the engaging position of the rotating body 192, and the engaging arm 195 and the detecting arm 196 rotates in the retract rotating direction. Accordingly, since the rotating body slider 106 moves to the retracting position with respect to the discharge driving roller 111, the driven side rotating body 105 supported by the rotating body slider 106 does not protrude to the driving side rotating body 104 side with respect to the discharge driving roller 111.

Accordingly, by interlocking with opening of the openable lid 6, the discharge driven roller 141 moves to the separation position, and the rotating body slider 106 moves to the retracting position with respect to the discharge driving roller 111, and thus a gap between the discharge driving roller 111 and the discharge driven roller 141 becomes wide, and a gap between the driving side rotating body 104 and the driven side rotating body 105 becomes wide. Therefore, when the tape cartridge C is set in the cartridge mounting portion 10, even when the printing tape T projects from the tape delivery opening 38, the printing tape T reliably enters between the discharge driving roller 111 and the discharge driven roller 141 and between the driving side rotating body 104 and the driven side rotating body 105 so that the tape cartridge C can be set.

As illustrated in FIGS. 10B, 11B, 12B, and 13B, after the tape cartridge C is mounted, when the openable lid 6 is closed, the actuating protrusion 6a of the openable lid 6 is engaged with the protrusion receiving portion 178 of the hook member 175, and the hook engaging portion 176 of the hook member 175 is engaged with and detached from the holder engagement receiving portion 168. As a result, the discharge driving roller 111 moves to the nip position from the separation position, and the rotating body 192 moves to the disengaging position from the engaging position. In conjunction with movement of the rotating body 192 to the disengaging position, the interlocking and engaging portion 198 is engaged with and detached from the interlocking and engaging receiving portion.

In a case in which the printing tape T is not pinched between the driving side rotating body 104 and the driven side rotating body 105, the engaging arm 195 and the detecting arm 196 rotate in the advance rotating direction. Accordingly, since the rotating body slider 106 moves to the advance position with respect to the discharge driving roller 111, the driven side rotating body 105 supported by the rotating body slider 106 is engaged in a state of being overlapped with the driving side rotating body 104. In addition, in this state, since the detecting arm 196 does not face the slider detector 193, the slider detector 193 detects that the rotating body slider 106 does not move to the retracting position, and the printing tape T is detected to be not present between the driving side rotating body 104 and the driven side rotating body 105 and between the discharge driving roller 111 and the discharge driven roller 141.

As illustrated in FIGS. 10C, 11C, 12C, and 13C, when the printing process is performed, and the printing tape T is inserted to between the discharge driving roller 111 and the discharge driven roller 141, the driven side rotating body 105 is supported so as to be capable of rotating in a vicinity of the driven roller shaft 171, and thus the driven side rotating body 105 rotates so as to receive the printing tape T, and the driving side rotating body 104 and the driven side rotating body 105 does not obstruct the passage of a medium to be sent.

Also, when the printing tape T is pinched between the driving side rotating body 104 and the driven side rotating body 105, the driven side rotating body is engaged with and detached from the driving side rotating body 104, and the state of being overlapped with the driving side rotating body 104 is released. Accordingly, the rotating body slider 106 supporting the driven side rotating body 105 moves to the retracting position from the advance position by releasing of the overlapped state in addition to a thickness of the printing tape T.

by interlocking with movement to the retracting position of the rotating body slider 106, the engaging arm 195 and the detecting arm 196 of the rotating body 192 rotate in the retract rotating direction, and the distal end portion of the detecting arm 196 faces the slider detector 193. Also, the slider detector 193 detects that the rotating body slider 106 moved to the retracting position, and detects that the printing tape T is present between the driving side rotating body 104 and the driven side rotating body 105 and between the discharge driving roller 111 and the discharge driven roller 141.

Here, in the rotating body 192, since the detecting arm 196 is formed to be longer than the engaging arm 195, and the distal end portion of the detecting arm 196 facing the slider detector 193 is installed in the outside of the radial direction further than an engaging portion of the engaging arm 195 with respect to the shaft portion 194, a rotating distance of the detecting arm 196 is longer than a rotating distance of the engaging arm 195 in accordance with a moving distance of the rotating body slider 106 between the advance position and the retracting position. Therefore, the movement of the rotating body slider 106 to the retracting position can be detected with high accuracy. In addition, as the rotating distance of the detecting arm 196 longer than the rotating distance of the engaging arm 195 in accordance with the moving distance of the rotating body slider 106, it is possible to reduce an overlapped part between the driving side rotating body 104 and the driven side rotating body 105.

As seen from the above, according to the tape printing device 1 of the embodiment, when the tape cartridge C is set to the cartridge mounting portion 10, even in a case in which the printing tape T projects from the tape delivery opening 38, the printing tape T reliably enters to between the discharge driving roller 111 and the discharge driven roller 141 and between the driving side rotating body 104 and the driven side rotating body 105 so that the tape cartridge C can be set. In addition, presence and absence of the printing tape T between the discharge driving roller 111 and the discharge driven roller 141 can be reliably detected.

Also, in the embodiment, as described above, a configuration including the driving side rotating body tooth portion 131 and the driven side rotating body tooth portion 136 respectively as the driving side rotating body 104 and the driven side rotating body 105 is described, but it is not limited thereto, a configuration may be used as long as the driving side rotating body 104 and the driven side rotating body 105 are engaged with each other in a state of being overlapped with each other and are engaged with and detached from each other due to the printing tape T which is pinched.

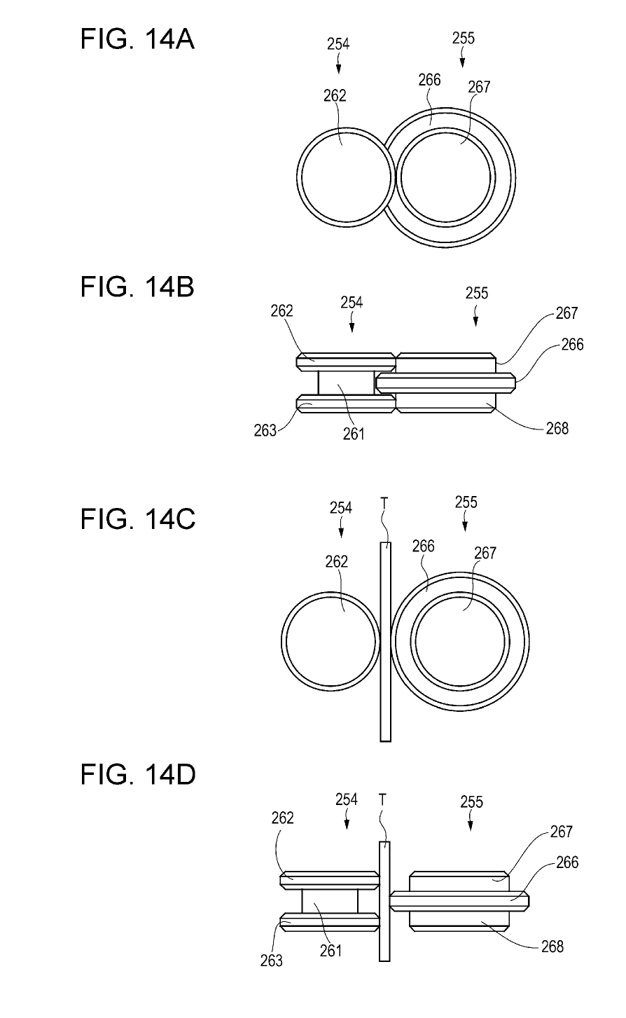

With reference to FIGS. 14A, 14B, 14C, and 14D, a driving side rotating body 254 and a driven side rotating body 255 according to another embodiment will be described. The driving side rotating body 254 is integrally formed with a driving side small diameter portion 261, a driving side first large diameter portion 262 and a driving side second large diameter portion 263 which are provided on both end surfaces of the driving side small diameter portion 261 coaxially with the driving side small diameter portion 261, as the entire body, the driving side rotating body is formed in a roller shape including a driving side unevenness portion (illustration is omitted) in which an outer circumferential surface is uneven in an axial direction. The driving side first large diameter portion 262 and the driving side second large diameter portion 263 are formed to have the substantially same diameter as that of the driving side upper roller main body 122 and the driving side lower roller main body 123 of the discharge driving roller 111, and in a state of being turnably attached to the driving roller shaft 121, the driving side first large diameter portion and the driving side second large diameter portion do not project in the radial direction with reference to the driving side upper roller main body 122 and the driving side lower roller main body 123.

The driven side rotating body 255 is integrally formed with a driven side large diameter portion 266, and a driven side first small diameter portion 267 and a driven side second small diameter portion 268 which are provided on both end surfaces of the driven side large diameter portion 266 coaxially with the driven side large diameter portion 266, as the entire body, the driven side rotating body is formed in a roller shape including a driven side unevenness portion (illustration is omitted) in which an outer circumferential surface is uneven in the axial direction and is complementary to the driving side unevenness portion. The driven side large diameter portion 266 is formed to have the substantially same diameter as that of the driven side upper roller main body 172 and the driven side lower roller main body 173 of the discharge driven roller 141, and in a state in which the rotating body slider 106 moves to the retracting position, the driven side large diameter portion does not project in the radial direction with respect to the driven side upper roller main body 172 and the driven side lower roller main body 173.

Also, illustration is omitted; however, but in the same manner as that of the embodiments described above, the driving side rotating body hole is formed in the driving side rotating body 254, and the driven side rotating body hole is formed in the driven side rotating body 255.

Even in this configuration, the driving side rotating body 254 and the driven side rotating body 255 are engaged in a state of being overlapped with each other, and is engaged with and detached from each other due to the printing tape T which is pinched. However, as the driving side rotating body 104 and the driven side rotating body 105 according to the embodiment described above, since the driving side rotating body tooth portion 131 and the driven side rotating body tooth portion 136 are respectively formed in a shape which becomes uneven in a circumferential direction, even when the printing tape T is thin or is made of a material having a weak elasticity, the printing tape T pinched between the driving side rotating body tooth portion 131 and the driven side rotating body tooth portion 136 is less likely to be bent in a shape in accordance with the driving side rotating body tooth portion 131 or the driven side rotating body tooth portion 136, and thus the overlapped state can be sufficiently released. Therefore, the rotating body slider 106 can be reliably moved by an overlapped amount.

According to the configuration described above, when a distal end of the printing tape T arrives at the tape discharging mechanism 12 (discharging section), a distal end of the printing tape T is smoothly drawn into between the discharge driving roller 111 and the discharge driven roller 141 facing the discharge driving roller 111, and thus a paper jam (tape clogging) is not generated. In addition, since the tape discharging mechanism 12 is configured to feed the printing tape T to the outside of the device so as to extend tape sending of the printing section 202, the printing tape T is held by being pinched between the discharge driving roller 111 and the discharge driven roller 141. Accordingly, a discharging position can be stabilized without flying a cut part of the printing tape T (tape piece) in all directions.

In addition, the sensing section 206 determines that presence and absence of the cut part (tape piece) of the printing tape T which is pinched and held between the discharge driving roller 111 and the discharge driven roller 141, and a next operation can be performed based on the determined result. That is, without performing any special operation, a next tape process (printing process) can be started, and thus the tape process (printing process) can be continuously performed.

In addition, the provided determining section 207 is capable of determining whether or not processing data relating to a tape process (printing process) remains, and is capable of selecting whether or not the next operation is performed based on the determined result. That is, in a case in which the processing data relating to the tape process (printing process) remains, a process is determined to be continuously performed, and starting of the next operation is selected, and in a case in which the processing data relating to the tape process does not remain, the tape process (printing process) is determined to be finished so that the tape process (printing process) can be finished.

In addition, the provided control section 200 is capable of controlling the next operation based on the determined result of presence and absence of the cut part (tape piece) of the printing tape T performed by the sensing section 206 or the determined result whether or not the processing data relating to the tape process remains performed by the determining section 207. Accordingly, the tape printing device 1 as a tape processing device which is capable of efficiently performing the tape process (printing process) can be provided.

Further, when the discharge driving roller 111 is rotated so that a circumferential velocity thereof is faster than a circumferential velocity of the platen roller 35, and the discharge driving roller 111 is smoothly rotated even when a predetermined load or more from the printing tape T is applied, it is possible to prevent a preceding jam of the printing tape T or the like and perform a normal tape sending. Accordingly, the tape process can be performed with high accuracy.

Also, in the embodiment, a configuration in which tape discharging after the cutting process is canceled, but a configuration in which the tape discharging after the cutting process is performed and the tape piece is completely discharged without cancelling may be used.

In addition, in the embodiment, a configuration in which the printing process is performed as the tape process, but it is not limited thereto, and for example, a configuration in which a braille embossing process is performed may be used, or a configuration in which a cutting process is performed may be used.

(Tape Processing Method)

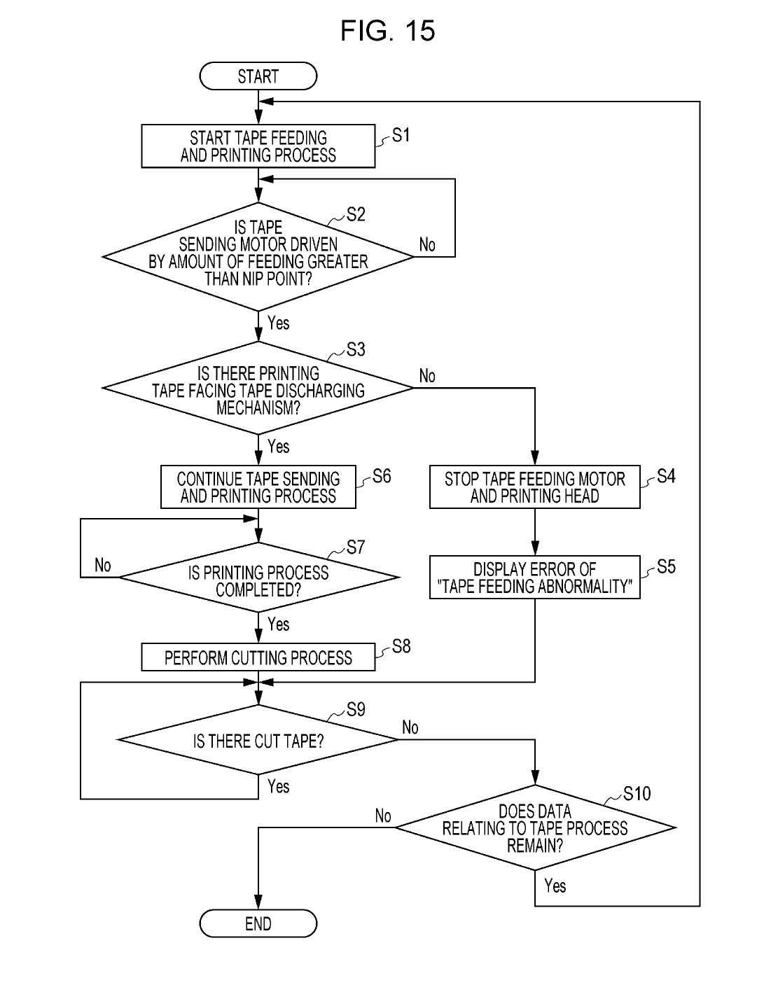

Next, as an example of the tape processing method, an operation of a tape process performed by the tape printing device 1 will be described with reference to FIG. 15. FIG. 15 is a flow chart illustrating an example of the tape processing method. Also, in description hereinafter, the configuration of the tape printing device 1 described above will be described using reference numerals thereof.

First, the control section 200 drives the printing section 202 (tape sending motor 41 and printing head 21) and starts tape sending and a printing process of the printing tape T (Step S1). Also, while performing the tape sending, the printing process is performed on the printing tape T. AT this time, the discharge driving roller 111 is rotated by interlocking with the platen roller 35, when a distal end of the printing tape T reaches a nip point of the tape discharging mechanism 12, the printing tape is drawn into a driving roller main body and a driven roller main body so as to be pinched and is fed so as to be rotatable.

If the tape sending motor 41 is continuously driven so as to be driven by a distance (amount of being fed) where the distal end of the printing tape T reaches (is assumed to reach) the nip point of the tape discharging mechanism 12 (Step S2: Yes), the detecting section 204 (mechanism of detecting presence and absence of tape) detects presence and absence of the printing tape T in the tape discharging mechanism 12 (Step S3). Also, if the tape sending motor is not driven by the distance (amount of being fed) where the distal end of the printing tape T reaches (is assumed to reach) the nip point of the tape discharging mechanism 12 (Step S2: No), the tape sending motor 41 is continuously driven.

In detection of presence and absence of the printing tape T in the tape discharging mechanism 12 (Step S3), in a case in which the printing tape T is not present (Step S3: No), travelling is determined to be abnormal, and the tape sending and the printing process stop. That is, the tape sending motor 41 and the printing head 21 stop (the printing section 202 and the discharging section (tape discharging mechanism 12) stop) (Step S4), and the display 9 displays an error of “tape sending abnormality” (Step S5).

Meanwhile, in a case in which the printing tape T is determined to be present (Step S3: Yes), tape sending and the printing process is continued (Step S6), the tape sending motor 41 and the printing head 21 are continuously driven until the printing process is completed. At this time, the printing tape T is sent by rotating the discharge driving roller 111. If the printing process is completed (Step S7: Yes), the cutting section 203 performs a tape cutting process (Step S8). In the tape cutting process, a tape is sent by driving the tape sending motor 41, a cut position of the printing tape T faces the full cutter 61 or the half cutter 62, the tape sending motor 41 stops, and then the cutter motor 63 is driven, the full cutter 61 or the half cutter 62 performs a cutting operation, and the cutting process is performed. That is, a printed part is cut by the cutting operation of the full cutter 61. At this time, by interlocking with the tape sending at the time of the cutting process, the discharge driving roller 111 is rotated, and a discharging process is performed. When the cut part of the printing tape T is cut by the cutting process of the full cutter 61, a distal end side of the printing tape T is in a state of being fed to the outside of the device, and a rear end side thereof is in a state of being held (pinched) by the tape discharging mechanism 12 due to the discharging process. That is, when the cut part of the printing tape T is cut, the cut tape piece is held by the tape discharging mechanism 12 in the state described above so as to be able to be removed by a user.

Next, the sensing section 206 determines whether or not the cut tape piece which is held by the tape discharging mechanism 12 is removed by the user (presence and absence of the tape piece) (Step S9). Also, in a case in which the tape piece is not present (Step S9: No), the tape piece is determined to be removed by the user, and the determining section 207 determines whether or not the data relating to tape process remains (Step S10). In addition, when the cut tape piece held by the tape discharging mechanism 12 is determined to be present or not present (Step S9), in a case in which the tape piece is determined to be present (Step S9: Yes), determination whether or not the tape piece is removed by the user (presence and absence of the tape piece) (Step S9) is repeated.

Determination performed by the determining section 207, in a case in which the data relating to tape process is determined to remain (Step S10: Yes), the determining section 207 transmits the determined result to the control section 200. Also, the control section 200 drives the printing section 202 (tape sending motor 41 and printing head 21) again, and causes the tape sending and the printing process of the printing tape T to start, the tape sending and the printing process of the printing tape T starts (Step S1), and a series of a flow restarts. That is, during remaining the data relating to tape process, a series of a print flow to be repeated is continuously performed. In addition, in a case in which the data relating to tape process is determined not to remain (Step S10: No), the printing tape T stops to be fed in this step. That is, a subsequent tape discharging is canceled, and the tape process operation is finished.

According to the tape processing method described above, since the tape process is performed while sending the processing tape, that is, sending of the printing tape T and the tape process (printing process) can be interlocked (synchronized) with each other, the printing tape T can be smoothly pinched in the step (Step S8) of cutting the printing tape T, and tape clogging can be suppressed. In addition, since the cut printing tape is held by the tape discharging mechanism 12 when the cut printing tape T is fed, the cut part (tape piece) of the printing tape T is not flown in all directions, and the discharging position thereof can be stabilized. In addition, the printing tape T which is held is determined to be present or not present, and an operation can be moved to a next operation based on the determined result thereof. That is, a flow of the next tape process (printing process) can be moved to a process of restarting without performing a special operation.

In addition, according to the tape processing method described above, whether or not the processing data relating to the tape process remains is determined, and whether or not the operation moves to the next operation can be selected based on the determined result. That is, in a case in which the processing data relating to the tape process remains, the processing is determined to be continuously performed, and the next operation is selected to restart, and in a case in which the processing data relating to the tape process does not remain, the process is determined to be finished so as to be capable of finishing the tape process. That is, even when a user does not command each time, the repetitive tape process to be repeated can be performed.

### REFERENCE SIGNS LIST

1 tape printing device as tape processing device
6 openable lid
10 cartridge mounting portion
12 tape discharging mechanism as discharging section
103 discharging power transmission mechanism as sending and interlocking section
104 driving side rotating body
105 driven side rotating body
106 rotating body slider
108 separating and contacting mechanism
111 discharge driving roller
141 discharge driven roller
193 slider detector
194 shaft portion
195 engaging arm
196 detecting arm
198 interlocking and engaging portion
200 control section
201 operating section
202 printing section as sending and processing section
203 cutting section
204 detecting section
205 driving section
206 sensing section
207 determining section
T printing tape

1. A tape processing device comprising:
a sending and processing section that performs a tape process while sending a processing tape;
a cutting section that is disposed on a downstream side of the sending and processing section in a tape sending direction and cuts the tape-processed processing tape;
a discharging section that is disposed on the downstream side of the cutting section in the tape sending direction, feeds the processing tape, and holds the cut processing tape;
a sending and interlocking section that interlocks driving of the sending and processing section with driving of the discharging section; and
a sensing section that determines presence and absence of the processing tape held in the discharging section.

2. The tape processing device according to claim 1, further comprising:
a determining section that determines whether or not processing data relating to the tape process remains.

3. The tape processing device according to claim 2, further comprising:
a control section that controls the sending and processing section, the cutting section, the discharging section, the sensing section, and the determining section.

4. A tape processing method comprising:
a step of performing a tape process while sending processing tape;
a step of cutting the tape-processed processing tape;
a step of feeding and holding the cut processing tape; and
a step of determining presence and absence of the held processing tape.

5. The tape processing method according to claim 4, further comprising:
a step of determining whether or not processing data relating to the tape process remains; and
a step of commanding a start of the subsequent tape process based on the determined result that or not the processing data remains.
